(19) United States
(12) Patent Application Publication
(10) Pub. No.: US 2022/0404155 A1
(43) Pub. Date: Dec. 22, 2022

(54) Alternative Navigation Directions Pre-Generated When a User is Likely to Make a Mistake in Navigation

(71) Applicant: GOOGLE LLC, Mountain View, CA (US)

(72) Inventors: Rachel Hausmann, Mountain View, CA (US); Collin Irwin, Mountain View, CA (US)

(21) Appl. No.: 17/057,071

(22) PCT Filed: Mar. 12, 2020
(86) PCT No.: PCT/US20/22353

§ 371 Date: Nov. 19, 2020

(51) Int. Cl. G01C 21/34; G01C 21/36

(52) U.S. Cl. CPC G01C 21/3415; G01C 21/3629; G01C 21/3667

(57) ABSTRACT

To predict a likelihood of an error by a user when traversing a route and take preemptive action, a computing device receives a request by a user for navigation directions from a starting location to a destination location via a route. The computing devices provides the set of navigation directions to the user, which includes navigation instructions each including a maneuver and a location on the route for the maneuver. For an upcoming maneuver on the route, the computing device determines a likelihood that the user will incorrectly perform the maneuver. In response to determining that the likelihood is above a threshold likelihood and prior to the user arriving at the location for the maneuver, the computing device generates an alternative set of navigation directions for navigating from a location off the route to the destination location via an alternative route.

### FIELD OF THE DISCLOSURE

The present disclosure relates to providing alternative navigation directions and, more particularly, to predicting a likelihood of an error by a user when traversing a route, and pre-generating alternative navigation directions based on the likelihood.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, software applications executing in computers, smartphones, etc. or embedded devices generate step-by-step navigation directions. Typically, a user specifies the starting point and the destination, and a software application displays and/or presents the directions in an audio format immediately and/or as the user travels from the starting point and the destination.

These software applications generally utilize indications of distance, street names, building numbers, to generate navigation directions based on the route. For example, these systems can provide to a driver such instructions as “proceed for one-fourth of a mile, then turn right onto Maple Street.”

### SUMMARY

To predict a likelihood of an error in navigation, a navigation error prediction system determines characteristics of an upcoming maneuver included in a set of navigation instructions. The characteristics may be characteristics of the maneuver itself, such as the type of maneuver, an initial lane position based on the previous maneuver and/or based on the current location of the user, a final lane position for performing the maneuver, a distance and/or time between the maneuver and the previous maneuver, a complexity level for the maneuver, etc., and/or characteristics regarding an environment for the maneuver, such as the noise level within the vehicle performing the maneuver, the location of the maneuver, the amount of traffic on the road where the maneuver is performed, the speed of the vehicle, whether an emergency vehicle passed by the vehicle as the vehicle approached the location of the maneuver, etc.

The navigation error prediction system may then determine the likelihood of the user incorrectly performing the maneuver based on these characteristics. For example, the likelihood may be higher for higher noise levels within the vehicle. In another example, the likelihood may be higher for higher complexity levels for the maneuvers. In some implementations, the navigation error prediction system may assign a score to one or more of these characteristics and then combine the characteristic scores in any suitable manner to generate an overall score for the upcoming maneuver. The navigation error prediction system may then determine the likelihood of the user incorrectly performing the maneuver according to the overall score.

In other implementations, the navigation error prediction system may utilize machine learning techniques to generate a machine learning model based on users' past experiences with various maneuvers and/or environments. For example, in one instance a user may have been unable to follow a navigation instruction when the radio was playing too loudly or a truck passed by. In another instance, a user may have been unable to follow a navigation instruction when the maneuver was a slight right turn on a six-way intersection and the user made a hard right turn.

Accordingly, the navigation error prediction system collects sets of maneuvers provided to users along with information regarding the environment in which the maneuvers were performed or attempted. For each maneuver, the navigation error prediction system collects an indication of whether the maneuver was performed correctly, and if not, the user's location after attempting the maneuver. This information is then used as training data to train the machine learning model to determine likelihoods that users will incorrectly perform maneuvers and/or predict locations where the users will be after attempting the maneuvers. For example, when the complexity level for a maneuver is high or very high, and the user is traveling over 60 mph, the machine learning model may determine that the likelihood that the user will incorrectly perform the maneuver is 0.7.

For an upcoming maneuver, the navigation error prediction system compares the determined likelihood that the user will incorrectly perform the maneuver to a threshold likelihood (e.g., 0.25). If the likelihood is above the threshold likelihood, the navigation error prediction system may take preemptive action. An example of a preemptive action may include generating an alternative set of navigation directions from a predicted location for the user after attempting the maneuver to the destination location. The alternative set of navigation directions may be generated before the user arrives at the location for the maneuver. In this manner, if the user is at a location which is off the route after attempting the maneuver, the user does not need to wait until an alternative set of navigation directions can be generated from the user's current location. Instead, the alternative set of navigation directions are pre-generated and provided to the user in a seamless manner, so that the user does not experience any further confusion and does not travel further away from the destination location as the navigation application recalculates the route.

Another example of a preemptive action may include providing a warning regarding the level of difficulty for performing the upcoming maneuver. In addition to the warning, the navigation error prediction system may provide user controls for the user to select an alternative route prior to arriving at the location for the upcoming maneuver.

The preemptive action may also include presenting the navigation instruction for the upcoming maneuver while the navigation instruction for the previous maneuver is presented. In this manner, the user may be made aware of the next maneuver before the user performs the previous maneuver so that the user can decide whether to perform the previous maneuver or request alternative navigation directions. Additionally, the user may be prepared to perform the next maneuver so that the user can take the necessary measures to perform the next maneuver immediately upon completing the previous maneuver. For example, a first maneuver may be to get onto the highway where the user merges into the left lane of a four lane highway. The next maneuver may be to exit the highway using the right lane 0.3 miles after entering the highway. In this scenario, the navigation instruction for exiting the highway may be presented along with the navigation instruction for entering the highway. In this manner, the user may determine that the next maneuver is too difficult and may not enter the highway, or the user may be prepared to change lanes immediately upon entering the highway so that the user can get over to the right lane before reaching the exit.

Yet other examples of preemptive actions may include repeating the navigation instruction that includes the upcoming maneuver, increasing the volume of an audio navigation instruction that includes the upcoming maneuver, increasing the length and/or level of detail of the navigation instruction that includes the upcoming maneuver, increasing the brightness of a display which presents a visual navigation instruction that includes the upcoming maneuver, increasing the size of the display for the visual navigation instruction, etc.

One example embodiment of the techniques of this disclosure is a method for predicting a likelihood of an error by a user when traversing a route. The method includes receiving a request by a user for navigation directions from a starting location to a destination location via a route, and providing to the user the set of navigation directions including a plurality of navigation instructions. Each navigation instruction includes a maneuver and a location on the route for the maneuver. For at least one upcoming maneuver on the route, the method includes determining a likelihood that the user will incorrectly perform the maneuver, and in response to determining that the likelihood is above a threshold likelihood and prior to the user arriving at the location for the maneuver, generating an alternative set of navigation directions for navigating from a location off the route to the destination location via an alternative route.

Another example embodiment is a computing device for predicting a likelihood of an error by a user when traversing a route, where the computing device includes one or more processors and a non-transitory computer-readable memory coupled to the one or more processors and storing thereon instructions. The instructions, when executed by the one or more processors, cause the computing device to receive a request by a user for navigation directions from a starting location to a destination location via a route, and provide to the user the set of navigation directions including a plurality of navigation instructions. Each navigation instruction includes a maneuver and a location on the route for the maneuver. For at least one upcoming maneuver on the route, the instructions cause the computing device to determine a likelihood that the user will incorrectly perform the maneuver, and in response to determining that the likelihood is above a threshold likelihood and prior to the user arriving at the location for the maneuver, generate an alternative set of navigation directions for navigating from a location off the route to the destination location via an alternative route.

Yet another example embodiment is a non-transitory computer-readable memory storing instructions thereon. When executed by one or more processors, the instructions cause the one or more processors to receive a request by a user for navigation directions from a starting location to a destination location via a route, and provide to the user the set of navigation directions including a plurality of navigation instructions. Each navigation instruction includes a maneuver and a location on the route for the maneuver. For at least one upcoming maneuver on the route, the instructions cause the one or more processors to determine a likelihood that the user will incorrectly perform the maneuver, and in response to determining that the likelihood is above a threshold likelihood and prior to the user arriving at the location for the maneuver, generate an alternative set of navigation directions for navigating from a location off the route to the destination location via an alternative route.

### BRIEF DESCRIPTION OF THE DRAWINGS

FIG. 1 illustrates an example vehicle in which the techniques of the present disclosure can be used to predict a likelihood of an error in navigation;

FIG. 2 is a block diagram of an example system in which techniques for predicting a likelihood of an error in navigation can be implemented;

FIGS. 3A and 3B illustrate example maneuvers which users have difficulty performing;

FIG. 4 is an example maneuver data table which the navigation error prediction system of FIG. 2 can utilize to generate a machine learning model for predicting a likelihood of an error by a user for a particular maneuver;

FIG. 5 is a combined block and logic diagram that illustrates the prediction of a likelihood of an error for a maneuver using a machine learning model;

FIG. 6 illustrates an example navigation display indicating a route from a starting location to a destination location and including a warning regarding a maneuver on the route; and

FIG. 7 is a flow diagram of an example method for predicting a likelihood of an error by a user when traversing a route, which can be implemented in a computing device that operates in, or cooperates with, a navigation error prediction system.

### DETAILED DESCRIPTION

### Overview

The subject matter described in this specification can be implemented in particular embodiments so as to realize one or more of the following advantages. By generating an alternative set of navigation directions in response to determining that the likelihood that the user will incorrectly perform a maneuver exceeds a threshold likelihood, the alternative set of navigation directions are prepared in advance of a potential mistake by the user so that the user is ready should the user incorrectly perform the maneuver. This means that corrective navigation directions are ready when needed—when the user has performed the maneuver incorrectly—and there is no delay in providing these instructions. This is important, as the alternative navigation instructions will be often need to be issued quickly following a mistake by the user in order to allow the user to effectively navigate to the destination. Any delay can increase the likelihood of further mistakes by the user and increase the likelihood that the user takes sub-optimal maneuvers that increase the time to the destination. Furthermore, by only generating alternative navigation directions when the likelihood of a mistake is above a threshold likelihood, the implementations described herein avoid excessive processing and data retrieval that would be associated with generating alternative navigation directions for every maneuver. This therefore provides improvements in computational efficiency.

In addition, implementations allow one or more of the navigation instructions to be adapted to improve clarity and reduce the likelihood of an error by the user. For instance, in response to determining that the likelihood that the user will incorrectly perform a maneuver is above a threshold likelihood, an adapted navigation instruction for the maneuver might be provided to the user that is adapted to increase the likelihood that the user will correctly understand the adapted navigation instruction. This might include increasing a volume of an instruction or increasing a display brightness or size of the instruction. This might further include presenting, within the adapted instruction, one or more repetitions of the instruction for the maneuver. This might further include extending the period over which the adapted instruction is provided or including, within the adapted instruction, one or more warnings or alerts to the user that the maneuver is difficult or that a mistake is otherwise likely. The adapted instruction might also by adapted to be provided over one or more additional interfaces. For instance, where instructions are otherwise being provided via a display interface, the adapted instruction might also be provided via an audio interface (or vice versa). By providing an adapted navigation instruction, the likelihood of the user incorrectly performing the maneuver is reduced, thereby potentially avoiding the need to issue corrective navigation directions/instructions.

### Example Hardware and Software Components

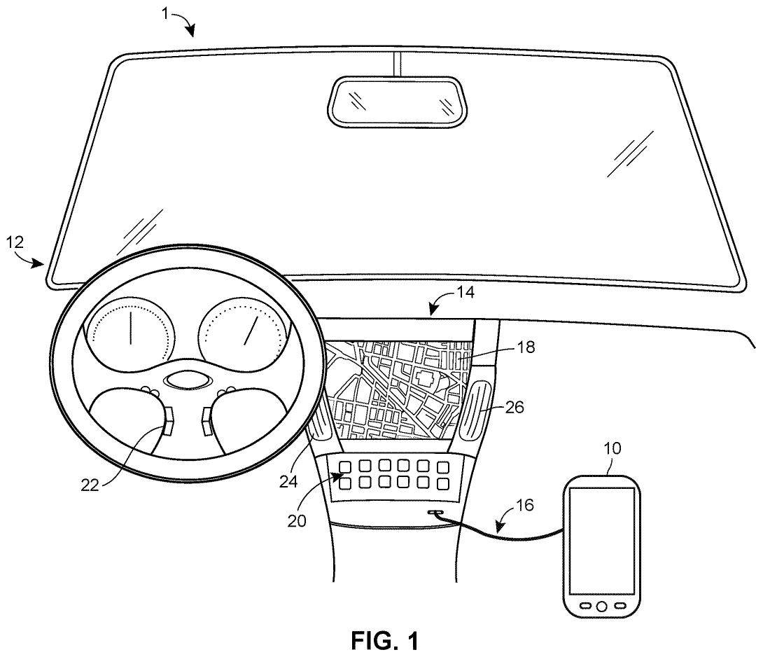

Referring to FIG. 1, an example environment 1 in which the techniques outlined above can be implemented includes a portable device 10 and a vehicle 12 with a head unit 14. The portable device 10 may be a smart phone or a tablet computer, for example. The portable device 10 communicates with the head unit 14 of the vehicle 12 via a communication link 16, which may be wired (e.g., Universal Serial Bus (USB)) or wireless (e.g., Bluetooth, Wi-Fi Direct). The portable device 10 also can communicate with various content providers, servers, etc. via a wireless communication network such as a fourth- or third-generation cellular network (4G or 3G, respectively).

The head unit 14 can include a display 18 for presenting navigation information such as a digital map. The display 18 in some implementations is a touchscreen and includes a software keyboard for entering text input, which may include the name or address of a destination, point of origin, etc. Hardware input controls 20 and 22 on the head unit 14 and the steering wheel, respectively, can be used for entering alphanumeric characters or to perform other functions for requesting navigation directions. The head unit 14 also can include audio input and output components such as a microphone 24 and speakers 26, for example. The speakers 26 can be used to play the audio instructions sent from the portable device 10.

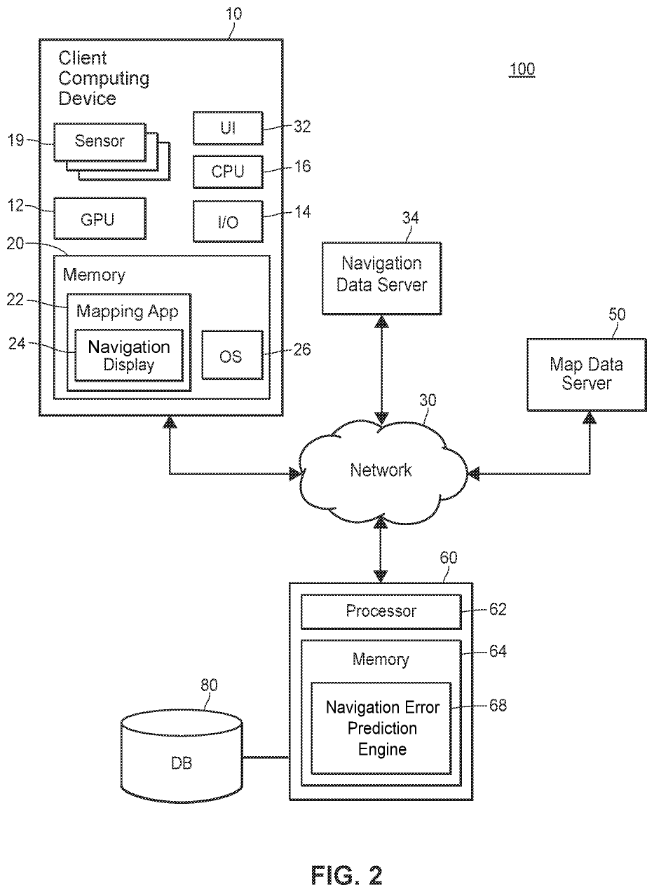

An example communication system 100 in which a navigation error prediction system can be implemented is illustrated in FIG. 2. The communication system 100 includes a client computing device 10 configured to execute a geographic application 22, which also can be referred to as “mapping application 22.” Depending on the implementation, the application 22 can display an interactive digital map, request and receive routing data to provide driving, walking, or other navigation directions including audio and visual navigation directions, provide various geolocated content, etc. The client computing device 10 may be operated by a user displaying a digital map while navigating to various locations.

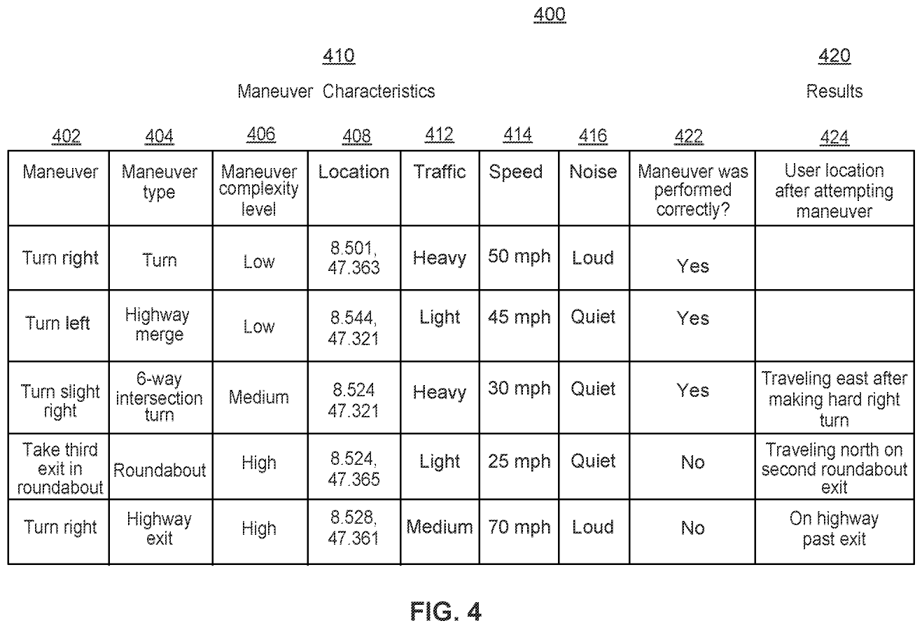

In addition to the client computing device 10, the communication system 100 includes a server device 60 configured to predict the likelihood of an error by a user when performing a maneuver and provide alternative navigation directions to the client device 10 based on the likelihood. The server device 60 can be communicatively coupled to a database 80 that stores, in an example implementation, a machine learning model for predicting the likelihood of an error when performing an upcoming maneuver in addition to training data for training the machine learning model. The training data may include sets of navigation instructions provided to users including maneuvers included in the sets of navigation instructions and characteristics of the maneuvers. The characteristics of the maneuvers may include the type of maneuver, an initial lane position based on the previous maneuver and/or based on the current location of the user, a final lane position for performing the maneuver, a distance and/or time between the maneuver and the previous maneuver, a complexity level for the maneuver, the noise level within the vehicle performing the maneuver, the location of the maneuver, the amount of traffic on the road where the maneuver is performed, the speed of the vehicle, whether an emergency vehicle passed by the vehicle as the vehicle approached the location of the maneuver, etc. Still further, for each maneuver, the training data may include an indication of whether the maneuver was performed correctly, and if not, the user's location after attempting the maneuver. The training data is described in further detail below with reference to FIG. 4.

More generally, the server device 60 can communicate with one or several databases that store any type of suitable geospatial information or information that can be linked to a geographic context. The communication system 100 also can include a navigation data server 34 that provides driving, walking, biking, or public transit directions, for example. Further, the communication system 100 can include a map data server 50 that provides map data to the server device 60 for generating a map display. The devices operating in the communication system 100 can be interconnected via a communication network 30.

In various implementations, the client computing device 10 may be a smartphone or a tablet computer. The client computing device 10 may include a memory 20, one or more processors (CPUs) 16, a graphics processing unit (GPU) 12, an I/O module 14 including a microphone and speakers, a user interface (UI) 32, and one or several sensors 19 including a Global Positioning Service (GPS) module. The memory 20 can be a non-transitory memory and can include one or several suitable memory modules, such as random access memory (RAM), read-only memory (ROM), flash memory, other types of persistent memory, etc. The I/O module 14 may be a touch screen, for example. In various implementations, the client computing device 10 can include fewer components than illustrated in FIG. 2 or conversely, additional components. In other embodiments, the client computing device 10 may be any suitable portable or non-portable computing device. For example, the client computing device 10 may be a laptop computer, a desktop computer, a wearable device such as a smart watch or smart glasses, etc.

The memory 20 stores an operating system (OS) 26, which can be any type of suitable mobile or general-purpose operating system. The OS 26 can include application programming interface (API) functions that allow applications to retrieve sensor readings. For example, a software application configured to execute on the computing device 10 can include instructions that invoke an OS 26 API for retrieving a current location of the client computing device 10 at that instant. The API can also return a quantitative indication of how certain the API is of the estimate (e.g., as a percentage).

The memory 20 also stores a mapping application 22, which is configured to generate interactive digital maps and/or perform other geographic functions, as indicated above. The mapping application 22 can receive navigation instructions and present the navigation instructions via the navigation display 24. The mapping application 22 also can display driving, walking, or transit directions, and in general provide functions related to geography, geolocation, navigation, etc., via the navigation display 24.

It is noted that although FIG. 2 illustrates the mapping application 22 as a standalone application, the functionality of the mapping application 22 also can be provided in the form of an online service accessible via a web browser executing on the client computing device 10, as a plug-in or extension for another software application executing on the client computing device 10, etc. The mapping application 22 generally can be provided in different versions for different respective operating systems. For example, the maker of the client computing device 10 can provide a Software Development Kit (SDK) including the mapping application 22 for the Android™ platform, another SDK for the iOS™ platform, etc.

In some implementations, the server device 60 includes one or more processors 62 and a memory 64. The memory 64 may be tangible, non-transitory memory and may include any types of suitable memory modules, including random access memory (RAM), read-only memory (ROM), flash memory, other types of persistent memory, etc. The memory 64 stores instructions executable on the processors 62 that make up a navigation error prediction engine 68, which can determine a likelihood of an error by a user for an upcoming maneuver, and take a preemptive action such as generating alternative navigation directions from a predicted location for the user after attempting the maneuver. The navigation error prediction engine 68 may determine the likelihood of an error by the user for the upcoming maneuver based on characteristics of the maneuver including characteristics of the environment for the maneuver, such as the amount of noise in the vehicle, the amount of traffic at the location for the maneuver, the speed of the vehicle as the vehicle approaches the location for the maneuver, etc. In some scenarios, the navigation error prediction engine 68 may generate a machine learning model for determine the likelihoods of errors by users for upcoming maneuvers. The navigation error prediction engine 68 may then apply the characteristics of an upcoming maneuver to the machine learning model to determine the likelihood of an error by the user for the upcoming maneuver. Additionally, the navigation error prediction engine 68 may provide the alternative navigation directions to the client device 10 which are then presented by the navigation display 24 for example, when the user's current location is off the route after attempting the upcoming maneuver. In some embodiments, the navigation error prediction engine 68 includes a machine learning engine described in more detail below.

The navigation error prediction engine 68 and the navigation display 24 can operate as components of a navigation error prediction system. Alternatively, the navigation error prediction system can include only server-side components and simply provide the navigation display 24 with instructions to present the navigation instructions. In other words, navigation error prediction techniques in these embodiments can be implemented transparently to the navigation display 24. As another alternative, the entire functionality of the navigation error prediction engine 68 can be implemented in the navigation display 24.

For simplicity, FIG. 2 illustrates the server device 60 as only one instance of a server. However, the server device 60 according to some implementations includes a group of one or more server devices, each equipped with one or more processors and capable of operating independently of the other server devices. Server devices operating in such a group can process requests from the client computing device 10 individually (e.g., based on availability), in a distributed manner where one operation associated with processing a request is performed on one server device while another operation associated with processing the same request is performed on another server device, or according to any other suitable technique. For the purposes of this discussion, the term “server device” may refer to an individual server device or to a group of two or more server devices.

In operation, the navigation display 24 operating in the client computing device 10 receives and transmits data to the server device 60. Thus, in one example, the client computing device 10 may transmit a communication to the navigation error prediction engine 68 (implemented in the server device 60) requesting navigation directions from a starting location to a destination. Accordingly, the navigation error prediction engine 68 may obtain a set of navigation directions in response to the request and provide the set of navigation directions to the client computing device 10.

Then for an upcoming maneuver, the navigation error prediction engine 68 obtains characteristics of the environment regarding the maneuver. This may include obtaining sensor data indicative of the environment surrounding the client computing device 10 for the upcoming maneuver, such as the noise level in the vehicle, the speed of the vehicle, etc. As a result, the navigation error prediction engine 68 may determine the likelihood that the user will incorrectly perform the upcoming maneuver based on the characteristics of the maneuver. The navigation error prediction engine 68 may then generate and provide an alternative set of navigation directions to the client computing device 10 in the event that the user makes a mistake in performing the maneuver.

The client computing device 10 may determine the current location of the user, and if the current location is off the route for the navigation directions, the client computing device 10 may present the alternative navigation directions. In other implementations, the navigation error prediction engine 68 may provide a warning to the client computing device 10 for the upcoming maneuver which may be presented on the navigation display 24. In yet other implementations, the navigation error prediction engine 68 may provide an adapted navigation instruction for the upcoming maneuver to the client computing device 10 which may be presented on the navigation display 24 to increase the likelihood that the user will correctly understand the adapted navigation instruction. The adapted navigation instruction may be repeated, may be presented with an increased volume or display brightness, may be presented for a longer period of time, or may be presented along with the previous navigation instruction while the previous navigation instruction is being presented.

The navigation error prediction engine 68 may obtain characteristics of the environment regarding an upcoming maneuver upon generating the navigation directions, after the previous maneuver has been completed, after the maneuver before the previous maneuver has been completed, after a maneuver a predetermined number of maneuvers before the upcoming maneuver has been completed, or at any other suitable time.

While the navigation error prediction system is described herein with reference to driving directions, this is for ease of illustration only. The navigation error prediction system may be implemented for walking, biking, public transit, or any suitable navigation directions. The noise level may be the noise level within the area surrounding the client computing device 10 and the speed data may be the speed of the client computing device 10 regardless of whether the client computing device 10 is within a vehicle.

In any event, the navigation error prediction engine 68 determines the likelihood that the user will incorrectly perform the upcoming maneuver based on the characteristics of the upcoming maneuver. In some implementations, the navigation error prediction engine 68 determines the likelihood that the user will incorrectly perform the upcoming maneuver based on the noise level within the vehicle. The navigation error prediction engine 68 may determine higher likelihoods for higher noise levels. Furthermore, the likelihood that the user will incorrectly perform the upcoming maneuver may be determined based on changes in the noise level. For example, if the noise level is a medium noise level but remains constant over time, the user may be less likely to misunderstand a navigation instruction than if there is a large increase in the noise level at the time the navigation instruction is presented to the user. Accordingly, the navigation error prediction engine 68 may determine higher likelihoods for larger increases in the noise level over time. In some implementations, the navigation error prediction engine 68 determines the likelihood that the user will incorrectly perform the upcoming maneuver based on suitable combination of the noise level and changes in the noise level.

In other implementations, the navigation error prediction engine 68 determines the likelihood that the user will incorrectly perform the upcoming maneuver based on a complexity level for the maneuver. The complexity level may be a complexity score such as from 1 to 100, may be a category such as “Very Low,” “Low,” “Medium,” “High,” “Very High,” etc., or may be indicated in any other suitable manner. The complexity level for a maneuver may be determined based on the maneuver type, such as a turn in a four-way intersection, a turn in a six-way intersection, a roundabout, a U-turn, a highway merge, a highway exit, etc. In some implementations, the complexity level for a maneuver may be determined based on a combination of the maneuver type and the location of the maneuver. If the maneuver is at a location where the maneuver type is common (e.g., the frequency of the maneuver type within a geographic area including the location exceeds a threshold frequency), the complexity level may be lower than if the maneuver is at a location where the maneuver type is uncommon. For example, in the United Kingdom where roundabouts are common, the complexity level may be lower than in the United States where roundabouts are uncommon.

The complexity level may also be determined based on the amount of time or distance between the upcoming maneuver and the previous maneuver. Maneuvers which occur shortly after previous maneuvers may have higher complexity levels. Furthermore, the complexity level may be determined based on the number of lanes that the user needs to change to perform the maneuver. For example, the navigation error prediction engine 68 may compare an initial lane for the user after performing the previous maneuver to a final lane for the user to perform the upcoming maneuver. The complexity level may increase as the number of lane changes increases for performing the maneuver.

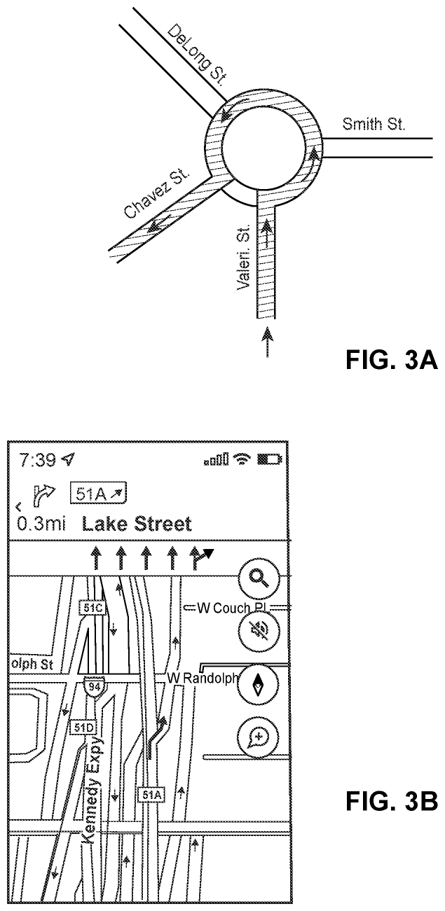

FIG. 3A illustrates one example of a difficult maneuver having a high complexity level (e.g., a complexity score of 70). As shown in FIG. 3A, the user is heading north on Valeri Street. As the user approaches the intersection, the maneuver is to take the third exit on the roundabout onto Chavez Street. As many users do not have significant experience with roundabouts, the user may accidentally take the first or second exit from the roundabout. FIG. 3B illustrates yet another example of a difficult maneuver having a high complexity level (e.g., a complexity score of 85). As shown in FIG. 3B, the user enters the highway merging from the left lane. The highway is a five-lane highway and the upcoming maneuver is to exit the highway from the far right lane in 0.3 miles. For the user to exit the highway at Lake Street, the user must move from the far left lane to the far right lane in less than 0.3 miles. This may not allow enough time for the user to make the requisite lane changes and the user may be unable to exit the highway at Lake Street.

In yet other implementations, the navigation error prediction engine 68 determines the likelihood that the user will incorrectly perform the upcoming maneuver based on any suitable combination of the noise level, the complexity level for the maneuver, and/or other characteristics for the maneuver. For example, the navigation error prediction engine 68 may assign a score to each of the characteristics for the maneuver and combine the scores in any suitable manner to generate an overall score for the maneuver. The navigation error prediction engine 68 may then determine the likelihood based on the overall score for the maneuver.

In other implementations, the navigation error prediction engine 68 generates a machine learning model for determining likelihoods that users will incorrectly perform maneuvers. To generate the machine learning model for determining likelihoods that users will incorrectly perform maneuvers, the navigation error prediction engine 68 obtains training data including sets of navigation instructions previously provided to users, where each navigation instruction includes a maneuver.

The training data may also include characteristics of each of these maneuvers including characteristics of the environments in which the maneuvers were performed. For example, users who select an option to share location data and/or other user data may transmit sets of navigation instructions presented by their respective client computing devices 10 along with sensor data from their respective client computing devices 10 collected when the navigation instructions were presented. The sensor data may include for each navigation instruction, the amount of traffic when the navigation instruction was presented, the time of day when the navigation instruction was presented, weather conditions when the navigation instruction was presented, the noise level when the navigation instruction was presented, the user's current location when the navigation instruction was presented, the user's current speed when the navigation instruction was presented, etc.

In some embodiments, the client computing device 10 determines the time of day and noise level via a clock and microphone, respectively, included in the client computing device 10. To determine the weather, the client computing device 10 may include a rain sensor or may communicate with an external service such as the National Weather service. For example, the client computing device 10 may communicate with the GPS module to obtain a current location and transmit a request to the National Weather service for weather data for a region that includes the current location. Likewise to determine the amount of traffic, the client computing device 10 may communicate with the GPS module to obtain a current location and transmit a request to a traffic service for traffic data for a region that includes the current location.

In any event, for each navigation instruction presented, the navigation error prediction engine 68 obtains the characteristics for the maneuver, an indication of whether the maneuver was performed correctly, and if not, the user's location after attempting the maneuver. For example, if the mapping application 22 generated a new route because the user's current location differed from the path of the original route after the navigation instruction was presented, the navigation error prediction engine 68 may receive an indication that the maneuver was not performed correctly and may receive an indication of the user's current location after attempting the maneuver.

The sets of navigation instructions, maneuver characteristics, indications of whether the maneuvers were performed correctly, and/or locations of the users after attempting the maneuvers may be provided as training data for generating the machine learning model using machine learning techniques.

### Example Training Data for Generating the Machine Learning Model

FIG. 4 illustrates example training data 400 that may be used to generate the machine learning model. In some embodiments, the training data 400 may be stored in the database 80. The training data 400 may include two portions: maneuver characteristics 410, and results of the attempted maneuvers 420. The maneuver characteristics 410 may include the maneuver 402, and the type of maneuver 404, such as a turn in a four-way intersection, a turn in a six-way intersection, a roundabout, a highway merge, a highway exit, a U-turn, a hard turn, a slight turn, a lane change, etc.

The maneuver characteristics 410 may also include a complexity level for the maneuver 406. The complexity level 406 may be a complexity score such as from 1 to 100, may be a category such as “Very Low,” “Low,” “Medium,” “High,” “Very High,” etc., or may be indicated in any other suitable manner. The complexity level 406 for a maneuver may be determined based on the maneuver type 404, such as a turn in a four-way intersection, a turn in a six-way intersection, a roundabout, a U-turn, a highway merge, a highway exit, etc. The complexity level 406 may also be determined based on the amount of time or distance between the upcoming maneuver and the previous maneuver. Maneuvers which occur shortly after previous maneuvers may have higher complexity levels. Furthermore, the complexity level 406 may be determined based on the number of lanes that the user needs to change to perform the maneuver. For example, the navigation error prediction engine 68 may compare an initial lane for the user after performing the previous maneuver to a final lane for the user to perform the upcoming maneuver. The complexity level 406 may increase as the number of lane changes increases for performing the maneuver.

Furthermore, the maneuver characteristics 410 may include the location of the maneuver 408. While the location column 408 in the data table 400 includes GPS coordinates, the location may be an intersection, street address, or any other suitable location.

Additionally, the maneuver characteristics 410 may include an amount of traffic at the location of the maneuver 412, categorized as light traffic, medium traffic, or heavy traffic. For example, light traffic for a road may indicate that vehicles on the road are traveling at or above the speed limit. Medium traffic for a road may indicate that vehicles on the road are traveling within a threshold speed below the speed limit (e.g., within 5-10 mph of the speed limit). Heavy traffic for a road may indicate that vehicles on the road are traveling at less than the threshold speed below the speed limit (e.g., less than 5-10 mph of the speed limit).

Moreover, the maneuver characteristics 410 may include a speed of the vehicle or the client computing device 10 as the user approaches the location of the maneuver 414, and a noise level 416 in or around the vehicle, such as background music or talking in the vehicle, street noise, honking, a phone ringing, etc. The noise level 416 may be indicated in decibels (dB) or categorized as quiet (e.g., below a first threshold decibel amount), medium (e.g., between the first threshold decibel amount and a second threshold decibel amount that is higher than the first threshold decibel amount), loud (e.g., above the second threshold decibel amount), etc. In some embodiments, the noise level 416 may also include an indication of the source of the noise, such as the radio or other music playing, street noise, etc. Also in some embodiments, the noise level 416 may include an indication of the change in noise level over time, such as from quiet to loud as the user approaches the location of the maneuver, from loud to medium, etc.

While the example training data 400 includes the maneuver 402, the type of maneuver 404, the maneuver complexity level 406, the location of the maneuver 408, traffic data 412, speed data 414, and noise data 416 as maneuver characteristics 410, these are merely a few examples of maneuver characteristics for ease of illustration only. Any suitable characteristics indicative of the maneuver and/or the environment regarding the maneuver may be used as maneuver characteristics 410, such as a location of the previous maneuver on the route, an amount of time or distance between consecutive maneuvers, a lane position of the vehicle, whether an emergency vehicle passed by the vehicle as the vehicle approached the location of the maneuver, etc.

In addition to maneuver characteristics 410, the training data 400 may include data indicative of the results of the attempted maneuvers 420. The data indicative of the results of the attempted maneuvers 420 may include an indication of whether the maneuver was performed correctly 422. For example, if the current location of the user differs from the path of the route after the user arrives at the location of the maneuver, the navigation error prediction engine 68 may receive an indication that the user made a mistake in performing the maneuver. The data indicative of the results of the attempted maneuvers 420 may also include an indication of the current location of the user after attempting the maneuver if the current location of the user differs from the path of the route. For example, when the maneuver is a slight right turn, the current location of the user may indicate that the user made a hard right turn. In another example, if the maneuver is to get off at the third exit of a roundabout, the current location of the user may indicate that the user got off at the second exit of the roundabout.

To generate the machine learning model, the navigation error prediction engine 68 may classify subsets of the training data 400 as corresponding to maneuvers performed correctly and maneuvers performed incorrectly. For example, the first row of training data 400 (including a right turn with a low complexity level in a loud environment) may be classified as corresponding to a maneuver which was performed correctly. The fourth row of training data 400 (including a roundabout with a high complexity level in a quiet environment) may be classified as corresponding to a maneuver which was performed incorrectly.

Then the navigation error prediction engine 68 may analyze the first and second subsets to generate the machine learning model. The machine learning model may be generated using various machine learning techniques such as a regression analysis (e.g., a logistic regression, linear regression, or polynomial regression), k-nearest neighbors, decisions trees, random forests, boosting, neural networks, support vector machines, deep learning, reinforcement learning, Bayesian networks, etc. In some embodiments, the navigation error prediction engine 68 may generate a first machine learning model for determining the likelihoods that users will incorrectly perform maneuvers, and a second machine learning model for predicting the locations of users after attempting the maneuvers.

For example, the machine learning model for determining likelihoods that users will incorrectly perform maneuvers may be a decision tree having several nodes connected by branches where each node represents a test on the maneuver characteristics (e.g., is the maneuver complexity level low?), each branch represents the outcome of the test (e.g., NO), and each leaf represents the likelihood that the user will incorrectly perform the maneuver (e.g., 0.4). In other implementations, each leaf may represent a range of likelihoods (e.g., 0.2-0.3).

More specifically, the navigation error prediction engine 68 may generate a decision tree where a first node corresponds to whether the noise level is loud. If the noise level is not loud, a first branch may connect to a second node which corresponds to whether the traffic is heavy. If the traffic is heavy, a second branch may connect to a third node which corresponds to whether the complexity level is high. If the complexity level is high, a third branch may connect to a leaf node which may indicate that the likelihood that the user will incorrectly perform the maneuver is 0.3. While the decision tree includes one leaf node and three branches, this is merely an example for ease of illustration only. Each decision tree may include any number of nodes, branches, and leaves, having any suitable number and/or types of tests on maneuver characteristics.

The machine learning model for predicting the locations of users after attempting the maneuvers may also be a decision tree having several nodes connected by branches where each node represents a test on the maneuver characteristics. In other implementations, the machine learning model for predicting the locations of users after attempting the maneuvers may be a neural network. For example, based on the training data the machine learning model may determine that when the user makes a mistake on a slight right turn the user is likely to have made a hard right turn. Therefore, the machine learning model may predict that the user will be at a location that corresponds to having made a hard right turn at the intersection for the maneuver. In another example, based on the training data the machine learning model may determine that when the user makes a mistake on a left turn at a location where the street sign is difficult to see and/or when the noise level is loud, the user is likely to keep going straight. Therefore, the machine learning model may predict that the user will be at a location that corresponds to continuing straight past the intersection for the maneuver.

### Example Logic for Predicting Errors in Navigation Using Machine Learning Techniques

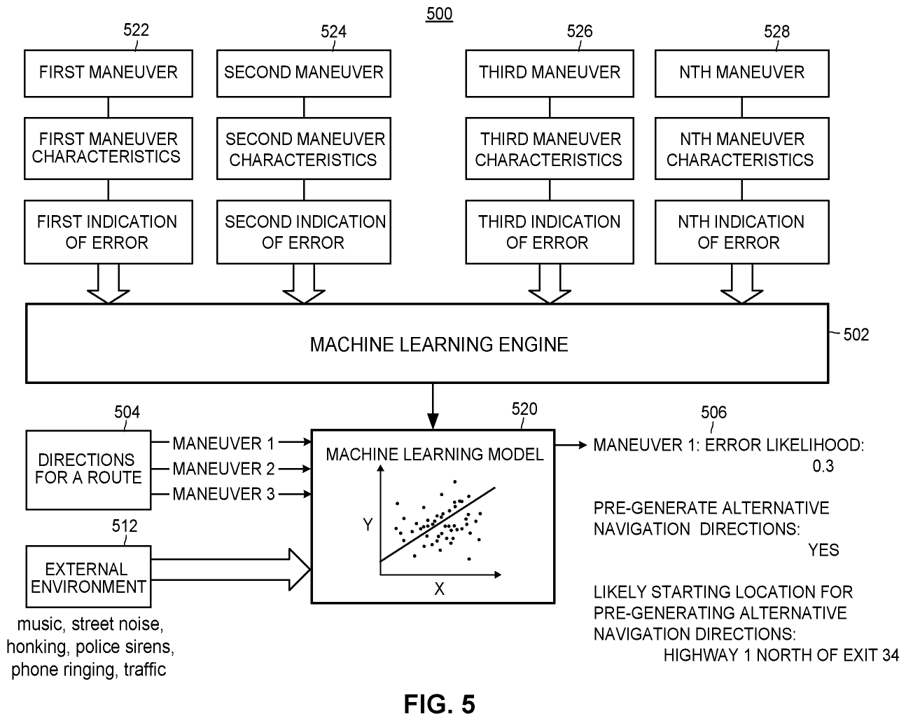

FIG. 5 schematically illustrates how the navigation error prediction engine 68 of FIG. 2 predicts errors in navigation for each maneuver in an example scenario. Some of the blocks in FIG. 5 represent hardware and/or software components (e.g., block 502), other blocks represent data structures or memory storing these data structures, registers, or state variables (e.g., blocks 504, 512, 520), and other blocks represent output data (e.g., block 506). Input signals are represented by arrows labeled with corresponding signal names.

The machine learning engine 502 of FIG. 5 may be included within the navigation error prediction engine 68 to generate the machine learning model 520. To generate the machine learning model 520, the machine learning engine 502 receives training data including a first maneuver 522 previously provided in a navigation instruction to a user along with a first set of maneuver characteristics when the first maneuver was provided, and a first indication of whether the user correctly performed the maneuver. The training data also includes a second maneuver 524 previously provided in a navigation instruction to the same or a different user along with a second set of maneuver characteristics when the second maneuver was provided, and a second indication of whether the user correctly performed the maneuver. Furthermore, the training data includes a third maneuver 526 previously provided to the same or a different user along with a third set of maneuver characteristics when the third maneuver was provided, and a third indication of whether the user correctly performed the maneuver. Still further, the training data includes an nth maneuver 528 previously provided to the same or a different user along with an nth set of maneuver characteristics when the nth maneuver was provided, and an nth indication of whether the user correctly performed the maneuver.

While the example training data includes four maneuvers 522-528 provided to the same or different users, this is merely an example for ease of illustration only. The training data may include any number of maneuvers from any number of users.

The machine learning engine 502 then analyzes the training data to generate a machine learning model 520 for determining likelihoods that users will incorrectly perform maneuvers and/or for predicting the locations of users after attempting the maneuvers. In some embodiments, the machine learning engine 502 generates a separate machine learning model for determining likelihoods that users will incorrectly perform maneuvers, and for predicting the locations of users after attempting the maneuvers. While the machine learning model 520 is illustrated as a linear regression model, the machine learning model may be another type of regression model such as a logistic regression model, a decision tree, neural network, hyperplane, or any other suitable machine learning model.

In any event, in response to a request for navigation directions by a user, the system of FIG. 5 receives a set of navigation instructions for a route 504 in a file from the navigation server 34, for example. In this example, the set of navigation instructions 504 includes descriptions of maneuvers 1-3, but in general the set of navigation instructions 504 can contain any number of maneuvers. For each maneuver in the set of navigation instructions 504, the system obtains maneuver characteristics including sensor data indicative of the external environment 512 surrounding the user's client computing device 10. The sensor data may include traffic data for the area surrounding the user's vehicle, visibility data such as the time of day and/or weather data for the area surrounding the user's vehicle, noise data indicative of the noise level in or around the vehicle, such as background music or talking in the vehicle, street noise, honking, a phone ringing, etc.

The machine learning engine 502 may then apply the maneuver characteristics including the sensor data indicative of the external environment 512 to the machine learning model 520 to determine a likelihood that the user will make a mistake when performing the maneuver. The machine learning engine 502 may also apply the maneuver characteristics to the machine learning model 520 to predict the location of the user after attempting the maneuver. In some implementations, the machine learning model 520 predicts the location of the user after attempting the maneuver when the likelihood that the user will make a mistake when performing the maneuver exceeds a threshold likelihood (e.g., 0.25).

For example, for the first maneuver 506, the machine learning model 520 determines that the likelihood that the user will make a mistake when performing the maneuver is 0.3. The machine learning model 520 predicts that the user's location after attempting the maneuver is on Highway 1 north of Exit 34. In this example, the maneuver may have been to exit Highway 1 at Exit 34, and the machine learning model 520 may determine that if the user did not get off at the exit, the user is most likely continuing straight on Highway 1.

In some embodiments, the navigation error prediction engine 68 compares the likelihood that the user will make a mistake when performing the maneuver to a threshold likelihood. In response to determining that the likelihood exceeds the threshold likelihood, the navigation error predicting engine 68 may generate an alternative set of navigation directions, for example from the predicted location of the user after attempting the maneuver to the destination location. The navigation error predicting engine 68 may receive the alternative set of navigation directions from the navigation server 34, for example. The navigation error prediction engine 68 may provide the alternative set of navigation directions to the user's client computing device 10, so that the user's client computing device 10 may present the alternative set of navigation directions without delay if the users travels off the route after attempting the maneuver.

In some implementations, the navigation error prediction engine 68 generates multiple alternative sets of navigation directions from multiple locations where the user may be after attempting the maneuver. For example, if the maneuver is to exit Highway 1 at Exit 34, the navigation error prediction engine 68 may generate a first alternative set of navigation directions from Highway 1 past Exit 34, a second alternative set of navigation directions from Exit 33, and a third alternative set of navigation directions from Exit 35. The navigation error prediction engine 68 may provide each alternative set of navigation directions to the user's client computing device 10. Then if the user makes a mistake when performing the maneuver, the client computing device 10 may determine the current location of the user after attempting the maneuver and may select the alternative set of navigation directions based on the current location of the user. For example, if the user's current location is at Exit 35, the client computing device 10 may present the third alternative set of navigation directions from Exit 35.

Also in some embodiments, the navigation error prediction engine 68 first provides the entire set of navigation instructions to the user's client computing device 10. Then for each maneuver, the navigation error prediction engine 68 receives and applies maneuver characteristics including characteristics indicative of the external environment 512 to the machine learning model 520. In turn, the machine learning model 520 determines the likelihood that the user will incorrectly perform the maneuver and the navigation error prediction engine 68 compares the likelihood to a threshold likelihood to determine whether to take preemptive action. In some implementations, the navigation error prediction engine 68 determines the likelihood that the user will incorrectly perform a maneuver after the user performs the previous maneuver. In other implementations, the navigation error prediction engine 68 determines the likelihood after the maneuver before the previous maneuver has been completed, after a maneuver a predetermined number of maneuvers before the maneuver has been completed, or at any other suitable time.

### Example Navigation Display

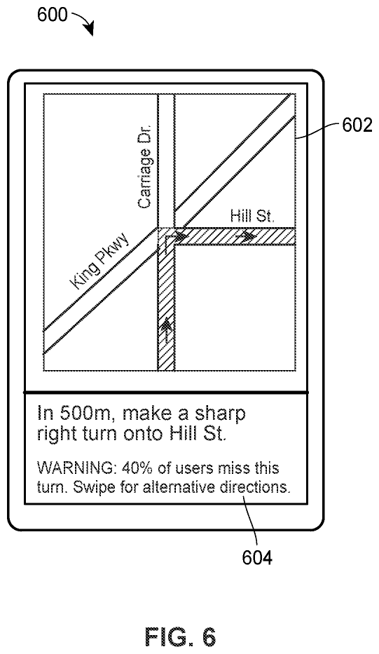

As mentioned above, when the navigation error prediction engine 68 determines that the likelihood that the user will make a mistake when performing a maneuver exceeds a threshold likelihood, the navigation error prediction engine 68 may take preemptive action to prevent the mistake from happening or to prevent the user from further confusion and/or mistakes. This may include generating an alternative set of navigation directions from a predicted location for the user after attempting the maneuver to the destination location. Preemptive action may also include providing a warning regarding the level of difficulty for performing the upcoming maneuver. FIG. 6 illustrates an example navigation display 600 indicating a route 602 from a starting location to a destination location and including a warning 604 regarding a maneuver on the route. As shown in FIG. 6, the maneuver includes a hard right turn in a five-way intersection which includes two types of right turns. The navigation error prediction engine 68 may determine that the likelihood that the user will incorrectly perform the maneuver is 0.4. Accordingly, the navigation error prediction engine 68 may provide a warning 604 to include in the navigation display 600 indicating that 40% of users miss the hard right turn. The warning 604 also includes an indication of user controls for the user to select an alternative route prior to arriving at the location for the upcoming maneuver. For example, the user may swipe right to receive alternative navigation directions which include continuing straight past the five-way intersection rather than making the hard right turn.

In other implementations, the navigation display 600 may present the navigation instruction for an upcoming maneuver while the navigation instruction for the previous maneuver is presented. In this manner, the user may be made aware of the next maneuver before the user performs the previous maneuver so that the user can decide whether to perform the previous maneuver or request alternative navigation directions. Additionally, the user may be prepared to perform the next maneuver so that the user can take the necessary measures to perform the next maneuver immediately upon completing the previous maneuver. For example, a first maneuver may be to get onto the highway where the user merges into the left lane of a four lane highway. The next maneuver may be to exit the highway using the right lane 0.3 miles after entering the highway. In this scenario, the navigation instruction for exiting the highway may be presented along with the navigation instruction for entering the highway. In this manner, the user may determine that the next maneuver is too difficult and may not enter the highway, or the user may be prepared to change lanes immediately upon entering the highway so that the user can get over to the right lane before reaching the exit.

In yet other implementations, the navigation error prediction engine 68 may cause the navigation instruction for an upcoming maneuver to be repeated when the likelihood exceeds a threshold likelihood. The navigation error prediction engine 68 may also increase the volume of an audio navigation instruction that includes the upcoming maneuver, may increase the length or level of detail of the navigation instruction that includes the upcoming maneuver, may increase the brightness of the navigation display 600 that includes the upcoming maneuver, may increase the size of the navigation display 600 that includes the upcoming maneuver, may cause both audio and visual navigation instructions to be presented via the speakers and display, respectively, of the client computing device 10, etc.

### Example Methods for Predicting Likelihoods Errors for Maneuvers

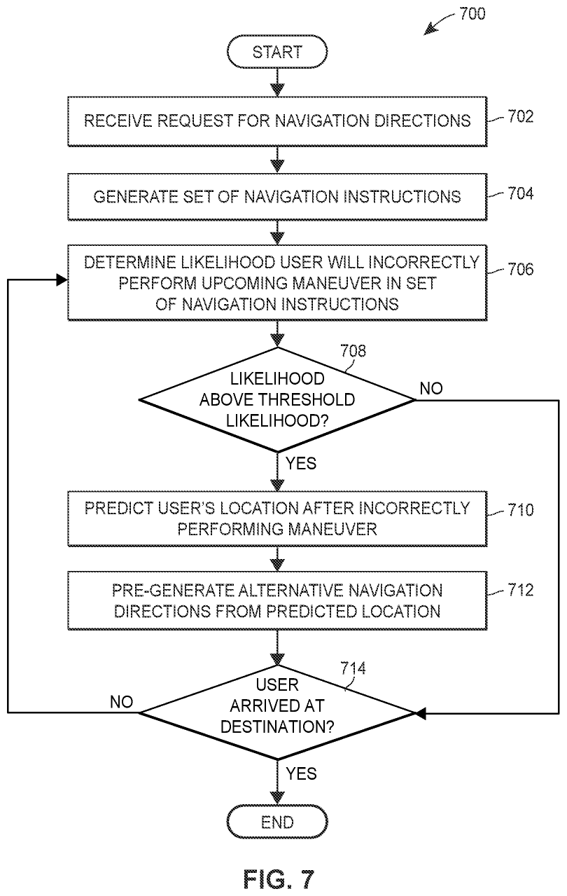

FIG. 7 illustrates a flow diagram of an example method 700 for predicting a likelihood of an error by a user when traversing a route. The method 700 can be implemented in a set of instructions stored on a computer-readable memory and executable at one or more processors of the server device 60. For example, the method can be implemented by the navigation error prediction engine 68.

At block 702, the navigation error prediction engine 68 receives a request for navigation directions from a starting location to a destination by a user's client computing device 10. The starting location may be the current location of the client computing device 10. In any event, in response to the request the navigation error prediction engine 68 generates a set of navigation instructions (block 704). The set of navigation instructions may be generated in a text format. Additionally, the navigation error prediction engine 68 may generate the set of navigation instructions by forwarding the request to the navigation data server 34 and receiving the set of navigation instructions from the navigation data server 34.

Then for an upcoming maneuver in the set of navigation instructions, the navigation error prediction engine 68 determines the likelihood that the user will incorrectly perform the maneuver (block 706), for example before the user arrives at the location for maneuver. In some embodiments, the navigation error prediction engine 68 determines the likelihood that the user will incorrectly perform an upcoming maneuver when the upcoming maneuver includes a turn. If the upcoming maneuver does not include a turn (e.g., the upcoming maneuver is to continue straight), the navigation error prediction engine 68 may not determine a likelihood that the user will incorrectly perform the maneuver to conserve resources and avoid excessive processing and data retrieval.

More specifically, the navigation error prediction engine 68 may obtain characteristics of the upcoming maneuver including characteristics of the maneuver itself (e.g., the type of maneuver, an initial lane position based on the previous maneuver and/or based on the current location of the user, a final lane position for performing the maneuver, a distance and/or time between the maneuver and the previous maneuver, a complexity level for the maneuver, etc.), and/or characteristics of the environment regarding the maneuver (e.g., the noise level within the vehicle performing the maneuver, the location of the maneuver, the amount of traffic on the road where the maneuver is performed, the speed of the vehicle, whether an emergency vehicle passed by the vehicle as the vehicle approached the location of the maneuver, etc.).

The navigation error prediction engine 68 may then determine the likelihood of the user incorrectly performing the maneuver based on these characteristics. For example, the likelihood may be higher for higher noise levels. In another example, the likelihood may be higher for higher complexity levels for the maneuvers. In some implementations, the navigation error prediction engine 68 may assign a score to one or more of these characteristics and then combine the characteristic scores in any suitable manner to generate an overall score for the upcoming maneuver. The navigation error prediction engine 68 may then determine the likelihood of the user incorrectly performing the maneuver according to the overall score. In other implementations, the navigation error prediction engine 68 may utilize machine learning techniques to generate a machine learning model based on users' past experiences with various maneuvers and/or environments to determine the likelihood of the user incorrectly performing the maneuver.

At block 708, the navigation error prediction engine 68 compares the likelihood to a threshold likelihood. If the likelihood exceeds the threshold likelihood, the navigation error prediction engine 68 may take preemptive action to prevent the mistake from happening or to prevent the user from further confusion and/or mistakes.

In some implementations, the navigation error prediction engine 68 predicts the location of the user after attempting the maneuver (block 710). For example, the navigation error prediction engine 68 may predict the location of the user after attempting the maneuver based on the location of the maneuver, such as based on the alternative maneuvers that the user could perform at the location of the maneuver.

The navigation error prediction engine 68 may identify candidate locations for the user after attempting the maneuver based on the alternative maneuvers that the user could perform at the location of the maneuver. Then the navigation error prediction engine 68 may assign scores to each of the candidate locations based on the likelihood that the user arrives at the candidate location after attempting the maneuver, and may rank the candidate locations according to the assigned scores. More specifically, the navigation error prediction engine 68 may identify and/or score each candidate location based on the location of the maneuver, a direction in which the user is travelling on the route as the user approaches the location of the maneuver, a type of the maneuver, and/or the alternative maneuvers that the user could perform at the location of the maneuver. The navigation error prediction engine 68 may select the candidate location having the highest score as the predicted location for the user after attempting the maneuver. In other implementations, the navigation error prediction engine 68 may predict the location of the user after attempting the maneuver by applying characteristics of the maneuver to a machine learning model, as described above.

In any event, the navigation error prediction engine 68 may then generate an alternative set of navigation directions for an alternative route from a location that does not correspond to the maneuver (i.e., a location off the path of the original route) to the destination location (block 712). The location that does not correspond to the maneuver may be the predicted location for the user. In other implementations, the navigation error prediction engine 68 generates multiple alternative sets of navigation directions from multiple locations where the user may be after attempting the maneuver. The navigation error prediction engine 68 may provide the alternative set or sets of navigation directions to the user's client computing device 10 before the user arrives at the location of the maneuver, so that the user's client computing device 10 may present the alternative set of navigation directions without delay if the users travels off the route after attempting the maneuver.

Then at block 714, the navigation error prediction engine 68 may determine whether the user arrives at the destination location. If the user arrives at the destination location, the process ends. Otherwise, the navigation error prediction engine 68 may determine the likelihood that the user will incorrectly perform the next upcoming maneuver (block 706).

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The method 700 may include one or more function blocks, modules, individual functions or routines in the form of tangible computer-executable instructions that are stored in a non-transitory computer-readable storage medium and executed using a processor of a computing device (e.g., a server device, a personal computer, a smart phone, a tablet computer, a smart watch, a mobile computing device, or other client computing device, as described herein). The method 700 may be included as part of any backend server (e.g., a map data server, a navigation server, or any other type of server computing device, as described herein), client computing device modules of the example environment, for example, or as part of a module that is external to such an environment. Though the figures may be described with reference to the other figures for ease of explanation, the method 700 can be utilized with other objects and user interfaces. Furthermore, although the explanation above describes steps of the method 700 being performed by specific devices (such as a server device 60 or client computing device 10), this is done for illustration purposes only. The blocks of the method 700 may be performed by one or more devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for predicting a likelihood of an error by a user when traversing a route through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for predicting a likelihood of an error by a user when traversing a route, the method comprising:
receiving, at one or more processors, a request by a user for navigation directions from a starting location to a destination location via a route;
providing to the user, by the one or more processors, the set of navigation directions including a plurality of navigation instructions, each navigation instruction including a maneuver and a location on the route for the maneuver;
for at least one upcoming maneuver on the route, determining, by the one or more processors, a likelihood that the user will incorrectly perform the maneuver; and
in response to determining that the likelihood is above a threshold likelihood and prior to the user arriving at the location for the maneuver, generating, by the one or more processors, an alternative set of navigation directions for navigating from a location off the route to the destination location via an alternative route.

2. The method of claim 1, further comprising:
determining, by the one or more processors, a current location of the user after the user arrives at the location for the maneuver;
determining, by the one or more processors, that the user incorrectly performed the maneuver based on the current location of the user; and
providing to the user, by the one or more processors, the alternative set of navigation directions for navigating from the current location of the user to the destination location via the alternative route.

3. The method of claim 1, wherein determining a likelihood that the user will incorrectly perform the maneuver includes:
determining, by the one or more processors, a noise level within a vehicle; and
determining, by the one or more processors, the likelihood that the user will incorrectly perform the maneuver based on the noise level within the vehicle.

4. The method of claim 1, wherein determining a likelihood that the user will incorrectly perform the maneuver includes:
determining, by the one or more processors, a complexity level for the maneuver; and
determining, by the one or more processors, the likelihood that the user will incorrectly perform the maneuver based on the complexity level for the maneuver.

5. The method of claim 1, wherein determining a likelihood that the user will incorrectly perform the maneuver includes:
determining, by the one or more processors, one or more characteristics of the at least one upcoming maneuver; and
applying a machine learning model to the at least one upcoming maneuver and the one or more characteristics of the at least one upcoming maneuver to determine the likelihood that the user will incorrectly perform the at least one upcoming maneuver.

6. The method of claim 5, wherein determining a likelihood that the user will incorrectly perform the maneuver includes:
training, by the one or more processors, a machine learning model for determining likelihoods that users will incorrectly perform maneuvers by using a plurality of maneuvers previously performed by a plurality of users while receiving navigation directions, including for each of the plurality of previously performed maneuvers, using (i) characteristics regarding an environment for the maneuver, and (ii) an indication of whether the maneuver was performed correctly.

7. The method of claim 6, wherein the one or more characteristics regarding the environment for the maneuver include at least one of:
a noise level in a vehicle,
a complexity level for the maneuver,
a speed of the vehicle,
a lane position of the vehicle,
a location of the maneuver,
a location of a previous maneuver on a route,
an amount of traffic at the location of the maneuver,
a type of maneuver,
an amount of time or distance between consecutive maneuvers, or
whether an emergency vehicle passed by the vehicle as the vehicle approached the location of the maneuver.

8. The method of claim 1, further comprising:
prior to the user arriving at the location for the maneuver, providing to the user, by the one or more processors, an adapted navigation instruction for the maneuver that is adapted to increase the likelihood that the user will correctly understand the adapted navigation instruction.

9. The method of claim 8, wherein the adapted navigation instruction includes one or more of:
a warning regarding the maneuver, or
a repetition of a navigation instruction corresponding to the maneuver.

10. The method of claim 8, wherein the adapted navigation instruction is adapted such that one or more of:
a display brightness of the adapted navigation instruction is increased,
a display size of the adapted navigation instruction is increased, or
a period over which the adapted navigation instruction is displayed is increased.

11. The method of claim 8, wherein the adapted navigation instruction is adapted such that one or more of:
a volume of the adapted navigation instruction is increased, or
a period over which the adapted navigation instruction is provided is extended.

12. The method of claim 1, wherein the location off the route is determined based on one or more of: the location for the maneuver, a direction in which the user is travelling on the route as the user approaches the location for the maneuver, a type of the maneuver, or one or more alternative maneuvers that can be performed at the location for the maneuver.

13. A computing device for predicting a likelihood of an error by a user when traversing a route, the computing device comprising:
one or more processors; and
a non-transitory computer-readable memory coupled to the one or more processors and storing instructions thereon that, when executed by the one or more processors, cause the computing device to:
receive a request by a user for navigation directions from a starting location to a destination location via a route;
provide to the user the set of navigation directions including a plurality of navigation instructions, each navigation instruction including a maneuver and a location on the route for the maneuver;
for at least one upcoming maneuver on the route, determine a likelihood that the user will incorrectly perform the maneuver;
in response to determining that the likelihood is above a threshold likelihood and prior to the user arriving at the location for the maneuver, generate an alternative set of navigation directions for navigating from a location off the route to the destination location via an alternative route.

14. The computing device of claim 13, wherein the instructions further cause the computing device to:
determine a current location of the user after the user arrives at the location for the maneuver;
determine that the user incorrectly performed the maneuver based on the current location of the user; and
provide to the user the alternative set of navigation directions for navigating from the current location of the user to the destination location via the alternative route.

15. The computing device of claim 13, wherein a likelihood that the user will incorrectly perform the maneuver is determined based on one or more of:
a noise level within a vehicle, or
a complexity level for the maneuver.

16. The computing device of claim 13, wherein to determine a likelihood that the user will incorrectly perform the maneuver, the instructions cause the computing device to:
determine one or more characteristics of the at least one upcoming maneuver; and
apply a machine learning model to the at least one upcoming maneuver and the one or more characteristics of the at least one upcoming maneuver to determine the likelihood that the user will incorrectly perform the at least one upcoming maneuver.

17. A non-transitory computer-readable memory storing instructions thereon that, when executed by one or more processors, cause the one or more processors to:
receive a request by a user for navigation directions from a starting location to a destination location via a route;
provide to the user the set of navigation directions including a plurality of navigation instructions, each navigation instruction including a maneuver and a location on the route for the maneuver;
for at least one upcoming maneuver on the route, determine a likelihood that the user will incorrectly perform the maneuver;
in response to determining that the likelihood is above a threshold likelihood and prior to the user arriving at the location for the maneuver, generate an alternative set of navigation directions for navigating from a location off the route to the destination location via an alternative route.

18. The non-transitory computer-readable memory of claim 17, wherein the instructions further cause the one or more processors to:
determine a current location of the user after the user arrives at the location for the maneuver;
determine that the user incorrectly performed the maneuver based on the current location of the user; and
provide to the user the alternative set of navigation directions for navigating from the current location of the user to the destination location via the alternative route.

19. The non-transitory computer-readable memory of claim 17, wherein a likelihood that the user will incorrectly perform the maneuver is determined based on one or more of:
a noise level within a vehicle, or
a complexity level for the maneuver.

20. The non-transitory computer-readable memory of claim 17, wherein to determine a likelihood that the user will incorrectly perform the maneuver, the instructions cause the one or more processors to:
determine one or more characteristics of the at least one upcoming maneuver; and
apply a machine learning model to the at least one upcoming maneuver and the one or more characteristics of the at least one upcoming maneuver to determine the likelihood that the user will incorrectly perform the at least one upcoming maneuver.
